(19) United States
(12) Patent Application Publication
(10) Pub. No.: US 2020/0271150 A1
(43) Pub. Date: Aug. 27, 2020

(54) LATERAL LOCATING DEVICE

(71) Applicant: TING-JUI WANG, New Taipei City (TW)

(72) Inventor: TING-JUI WANG, New Taipei City (TW)

(21) Appl. No.: 16/798,454

(22) Filed: Feb. 24, 2020

(30) Foreign Application Priority Data
Feb. 27, 2019 (TW) 108106931

(51) Int. Cl. F16B 21/07; B29C 43/00; B29C 65/02

(52) U.S. Cl. CPC F16B 21/075; B29C 65/02; B29C 43/00

(57) ABSTRACT

A lateral locating device includes a body, which is for assembling in a first direction thereof to a first object. The body has in a second direction a fastening portion or a leaning portion for fastening connecting, interfering or bearing in the second direction a second object or another object. Thus, the body can be securely coupled at the first object, and the second object or the another object can be coupled or removed by using the fastening portion or the leaning portion, so as to complete coupling or separation of at least two objects, achieving the effect of repeated quick coupling and separation.

### CROSS-REFERENCE TO RELATED APPLICATION

This non-provisional application claims priority under 35 U.S.C. § 119(a) on Patent Application No(s). 108106931 filed in Taiwan, R.O.C. on Feb. 27, 2019, the entire contents of which are hereby incorporated by reference.

### BACKGROUND OF THE INVENTION

### 1. Field of the Invention

The present invention relates to a lateral locating device, and more particularly to a lateral locating device capable of completing coupling or separation of at least two objects, thereby achieving repeated quick coupling and separation.

### 2. Description of the Related Art

When coupling at least one object, lock connection is usually performed by using a screw, so as to couple the object.

However, the conventional fixing means above can result in an insecure assembly although being capable of coupling at least one object into a form that is not easily separated.

Therefore, the present invention aims to disclose an invention of a lateral locating device capable of securely coupling to a first object as well as coupling or removing a second object or another object, so as to complete coupling or separation of at least two objects, thereby achieving the effect and object of repeated quick coupling and separation.

### BRIEF SUMMARY OF THE INVENTION

In view of the issues and drawbacks of the prior art, the inventor has dedicated to research and development of a lateral locating device capable of securely coupling to a first object as well as coupling or removing a second object or another object, so as to complete coupling or separation of at least two objects, thereby achieving the effect and object of repeated quick coupling and separation.

To achieve the above and other objects, the present invention provides a lateral locating device including: a body, for assembling in a first direction thereof to a first object, the body having in a second direction thereof a fastening portion or a leaning portion for fastening connecting, interfering or bearing in the second direction a second object or another object.

In the foregoing lateral locating device, the body has a shoulder, which is for receiving leaning of the second object or another object.

In the foregoing lateral locating device, the first object, the second object or another object is a board, a plate, a block, a circuit board, a metal plate, a plastic plate cylinder, an outer thread, an inner thread, an outer fastener, an inner fastener or an elastic fastener.

In the foregoing lateral locating device, the body has an assembly portion, which is for assembling to the first object.

In the foregoing lateral locating device, the assembly portion has a feed groove for receiving pressure of an external force, so as to have the material of the first object be pressed or flown into the feed groove and to assemble the assembly portion with the first object.

In the foregoing lateral locating device, the body has a stamping surface at an end surface thereof. The stamping force is for receiving stamping of a stamping part to assemble the assembly portion with the first object.

The foregoing lateral locating device further includes a carrier. The carrier is for carrying the lateral locating device, and can be provided with or without a cover.

In the foregoing lateral locating device, the body is picked up by a tool and placed at the first object for assembly.

In the foregoing lateral locating device, the body is picked up by a tool, and a comparison device compares the body and an assembly position of the first object and precisely places the assembly portion at the assembly position of the first object.

In the foregoing lateral locating device, the body has a welding surface, which is for being heated and welded in the first direction to the first object and cooled to complete the assembly.

In the foregoing lateral locating device, a solder layer is present at a solder position in the first direction of each of the first object and the body.

In the foregoing lateral locating device, after the tool picks up the body, an assembled portion for placing the first object is for assembling to the first object by stamping, assembling to the first object by welding, assembling to the first object by lock connection, assembling to the first object by expansion connection, or assembling to the first object by engaging connection.

In the foregoing lateral locating device, the first object has an assembled portion, which is a through hole, a plane, a groove, a recess or a protrusion.

In the foregoing lateral locating device, the assembly portion is pressurized by an external force to assemble to the first object by expansion connection.

In the foregoing lateral locating device, the fastening portion is an inner thread, a hole, a recess, a groove, a column, an outer thread, a protruding fastener, an inner fastener, a leaning portion or a step portion.

In the foregoing lateral locating device, the fastening portion is a protruding fastener, the protruding fastener has a protruding fastening portion and a neck, and an outer diameter of the protruding fastening portion is larger than an outer diameter of the neck.

In the foregoing lateral locating device, the body can be assembled with the first object by means of rivet connection, expansion connection, welding connection, lock connection, engaging connection or an elastic engaging connection.

In the foregoing lateral locating device, the body and the first object can be a formed integral.

In the foregoing lateral locating device, an angle between the first direction and the second direction of the body is 90 degrees, approximating 90 degrees, 60 to 120 degrees or 30 to 150 degrees.

In the foregoing lateral locating device, the body has a leaning surface on a surface near the fastening portion, and the leaning surface is for receiving leaning of the second object or the another object.

In the foregoing lateral locating device, the leaning surface is a planar surface, a stepped surface, a recessed surface, a protruding surface, an inclined surface, an arc surface or a curved surface.

In the foregoing lateral locating device, the protruding fastening portion is for fastening into a corresponding fastening portion of another object or the second object, and the corresponding fastening portion has an inserting portion and a fitting portion.

In the foregoing lateral locating device, the protruding fastening portion is for passing through the inserting portion and is then fastened in the fitting portion by using the neck, so as to fit the fitting portion between the protruding fastening portion and the body.

In the foregoing lateral locating device, the protruding fastener is for fastening into a corresponding fastening portion of another object or the second object, and the corresponding fastening portion has an inserting portion and a fitting portion. The fastening portion has a protruding fastening portion, a neck, and a limiting portion extended from the neck, and further includes an elastic element. One end of the elastic element is abutted against the body, and the other end is abutted against the limiting portion. Thus, the protruding fastening portion is defined to be constantly in a retracted position. Further, for engaging fastening, the protruding fastening portion is caused to enter the inserting portion and be fastened into the fitting portion, and is constantly fitted in the fitting portion by using the elastic force of the elastic element, so as to fit the fitting portion between the protruding fastening portion and the body.

In the foregoing lateral locating device, the protruding fastener is for fastening into a corresponding fastening portion of another object or the second object. The corresponding fastening portion has an inserting portion, an intermediate portion and a fitting portion. The fastening portion has a protruding fastening portion, an engaging fastening portion, a neck, and a limiting portion extended from the neck, and further includes an elastic element. One end of the elastic element is abutted against the body, and the other end is abutted against the limiting portion. Thus, the protruding fastening portion and the engaging fastening portion are defined to be constantly in a retracted position. For engaging fastening, the protruding fastening portion is caused to enter the inserting portion, pass through the intermediate portion by using the neck and be fastened with the fitting portion by using the engaging fastening portion, and is constantly fitted in the fitting portion by using the elastic force of the elastic element, so as to fit the fitting portion between the protruding fastening portion and the body.

In the foregoing lateral locating device, the protruding fastener is for fastening into a corresponding fastening portion of another object or the second object. The corresponding fastening portion has a fitting portion. The fastening portion has a protruding fastening portion, a neck, and a limiting portion extended from the neck, and further includes an elastic element. One end of the elastic element is abutted against the body, and the other end is abutted against the limiting portion. Thus, the protruding fastening portion is defined to be constantly in a retracted position. For engaging fastening, the neck is fastened into the fitting portion, and is constantly fitted in the fitting portion by using the elastic force of the elastic element, so as to fit the fitting portion between the protruding fastening portion and the body.

In the foregoing lateral locating device, the protruding fastener is for fastening into a corresponding fastening portion of another object or the second object. The corresponding fastening portion has an intermediate portion and an fitting portion. The fastening portion has a protruding fastening portion, an engaging fastening portion, a neck, and a limiting portion extended from the neck, and further includes an elastic element. One end of the elastic element is abutted against the body, and the other end is abutted against the limiting portion. Thus, the protruding fastening portion and the engaging fastening portion are defined to be constantly in a retracted position. For engaging fastening, the neck passes through the intermediate portion and is fastened with the fitting portion by using the engaging fastening portion, and is constantly fitted in the fitting portion by using the elastic force of the elastic member, so as to fit the fitting portion between the protruding fastening portion and the body.

In the foregoing lateral locating device, the fastening portion has an extension portion having a limiting portion, and further includes an elastic element. One end of the elastic member is abutted against the fastening portion, and the other end is abutted against the body. The fastening portion is constantly in an uplifted position or a retracted position by using the elastic force of the elastic element.

In the foregoing lateral locating device, the elastic element provides the fastening portion with an uplifting elastic force for guiding and fastening into another object or the second object, or for providing another object or the second object with an elastic force or shock absorption.

In the foregoing lateral locating device, another object or the second object has a corresponding fastening portion, which is a hole, a groove, a pear-shaped hole, a through channel, a through hole, a recess, a protrusion, a stepped body, a planar body, an arc body, a curved body, a channel-like fitting portion, a hole-like fitting portion, a channel-like intermediate portion, or a hole-like inserting portion.

The foregoing lateral locating device further includes an elastic element. One end of the elastic element is abutted against the body, and the other end is abutted against the fastening portion. The elastic element is a spring, an elastic piece, or an elastic column.

In the foregoing lateral locating device, the elastic force of the elastic element thrusts toward the second direction.

In the foregoing lateral locating device, the body and the fastening portion are a formed integral or a formed assembly.

In the foregoing lateral locating device, the body and the fastening portion can be can be assembled by means of movable assembly, fixed riveting connection assembly, fixed expansion connection assembly, lock connection assembly, fastening connection assembly, welding connection assembly, elastic fastening connection assembly, insertion connection assembly or liquid injection before recurring and coupling.

In the foregoing lateral locating device, an angle combination of 90 degrees or approximating 90 degrees between the first direction of the body and the first object is for allowing another object or the second object to steadily engagingly connect, interfere or bearing the first object by an angle of 90 degrees or approximating 90 degrees.

In the foregoing lateral locating device, the first direction and the second direction are the same direction or approximating directions.

In the foregoing lateral locating device, when the fastening portion is a slot, the first direction and the second direction are the same direction or approximating directions.

In the foregoing lateral locating device, the fastening portion or the leaning portion is a movable part for movably fastening connecting, interfering or receiving leaning of the second object or another object.

In the foregoing lateral locating device, the movable part is a sphere or a wheel.

In the foregoing lateral locating device, another movable part is present between the movable part and the body to increase rolling or moving efficiency of the movable part.

In the foregoing lateral locating device, the body has a stopping portion for stopping the movable part from departing the body.

In the foregoing lateral locating device, the stopping part is larger than an outer diameter of the movable part, and is for being deformed by pressure of an external force after the movable part is placed in a placement portion of the body, so as to limit the movable part within the placement portion by the stopping portion.

In the foregoing lateral locating device, the movable part is bolt connected at the body by an assembly part.

In the foregoing lateral locating device, the movable part is placed in a placement portion of the body.

In the foregoing lateral locating device, the second object or another object is for sliding, moving or rolling on the movable part, or the second object or another object is for driving the movable part to roll, move or slide.

In the foregoing lateral locating device, after the movable part is placed in a placement portion of the body, pressure of an external force is applied on the body to deform the material of the body to form a stopping portion, so as to limit the movable part within the placement portion by the stopping portion.

In the foregoing lateral locating device, the body has in the first direction a stamping surface at an end surface thereof, and the stamping surface receives stamping of a stamping part to assemble the assembly portion with the first object.

Thus, the lateral locating device of the present invention is capable of securely coupling the body to the first object, as well as coupling or removing the second object or another object by using the fastening portion or the leaning portion, so as to complete coupling or separation of at least two objects, thereby achieving the object of repeated quick coupling and separation.

### BRIEF DESCRIPTION OF THE DRAWINGS

FIG. 1 is an appearance schematic diagram according to a first embodiment of the present invention.

FIG. 2 is a schematic diagram of a state of use according to the first embodiment of the present invention.

FIG. 3 is an appearance schematic diagram according to a second embodiment of the present invention.

FIG. 4 is a section schematic diagram according to the second embodiment of the present invention.

FIG. 5 is an appearance schematic diagram according to a third embodiment of the present invention.

FIG. 6 is a section schematic diagram according to the third embodiment of the present invention.

FIG. 7 is an appearance schematic diagram according to a fourth embodiment of the present invention.

FIG. 8 is a section schematic diagram according to the fourth embodiment of the present invention.

FIG. 9 is an appearance schematic diagram according to a fifth embodiment of the present invention.

FIG. 10 is a section schematic diagram according to the fifth embodiment of the present invention.

FIG. 11 is a schematic diagram of different forms of a fastening portion of the present invention.

FIG. 12 is an appearance schematic diagram according to a sixth embodiment of the present invention.

FIG. 13 is a schematic diagram of a state of use according to a seventh embodiment of the present invention.

FIG. 14 is a schematic diagram of a state of use according to an eighth embodiment of the present invention.

FIG. 15 is a schematic diagram of a state of use according to a ninth embodiment of the present invention.

FIG. 16 is a schematic diagram of a state of use according to a tenth embodiment of the present invention.

FIG. 17 is a schematic diagram of a state of use according to an eleventh embodiment of the present invention.

FIG. 18 is a section schematic diagram according to a twelfth embodiment of the present invention.

FIG. 19 is an appearance schematic diagram according to the twelfth embodiment of the present invention.

FIG. 20 is a first schematic diagram of a state of use according to the twelfth embodiment of the present invention.

FIG. 21 is a second schematic diagram of a state of use according to the twelfth embodiment of the present invention.

FIG. 22 is a third schematic diagram of a state of use according to the twelfth embodiment of the present invention.

FIG. 23 is a section schematic diagram according to a thirteenth embodiment of the present invention.

FIG. 24 is a first schematic diagram of a state of use according to the thirteenth embodiment of the present invention.

FIG. 25 is a second schematic diagram of a state of use according to the thirteenth embodiment of the present invention.

FIG. 26 is a third schematic diagram of a state of use according to the thirteenth embodiment of the present invention.

FIG. 27 is a section schematic diagram according to a fourteenth embodiment of the present invention.

FIG. 28 is a first schematic diagram of a state of use according to the fourteenth embodiment of the present invention.

FIG. 29 is a second schematic diagram of a state of use according to the fourteenth embodiment of the present invention.

FIG. 30 is a third schematic diagram of a state of use according to the fourteenth embodiment of the present invention.

FIG. 31 is a schematic diagram of a state of use according to a fifteenth embodiment of the present invention.

FIG. 32 is a schematic diagram of a state of use according to a sixteenth embodiment of the present invention.

FIG. 33 is a schematic diagram of a state of use according to a seventeenth embodiment of the present invention.

FIG. 34 is a schematic diagram of different forms of an elastic element of the present invention.

FIG. 35 is a schematic diagram of a state of use according to an eighteenth embodiment of the present invention.

FIG. 36 is a schematic diagram of a state of use according to a nineteenth embodiment of the present invention.

FIG. 37 is a schematic diagram of a state of use according to a twentieth embodiment of the present invention.

FIG. 38-1 is a first schematic diagram of an assembly according to the twentieth embodiment of the present invention.

FIG. 38-2 is a second schematic diagram of an assembly according to the twentieth embodiment of the present invention.

FIG. 39 is a schematic diagram of a state of use according to a twenty-first embodiment of the present invention.

FIG. 40 is a schematic diagram of a state of use according to a twenty-second embodiment of the present invention.

FIG. 41 is a schematic diagram of a state of use according to a twenty-third embodiment of the present invention.

### DETAILED DESCRIPTION OF THE INVENTION

To fully understand the object, features and effects of the present invention, details of the present invention are given in specific embodiments with the accompanying drawings below.

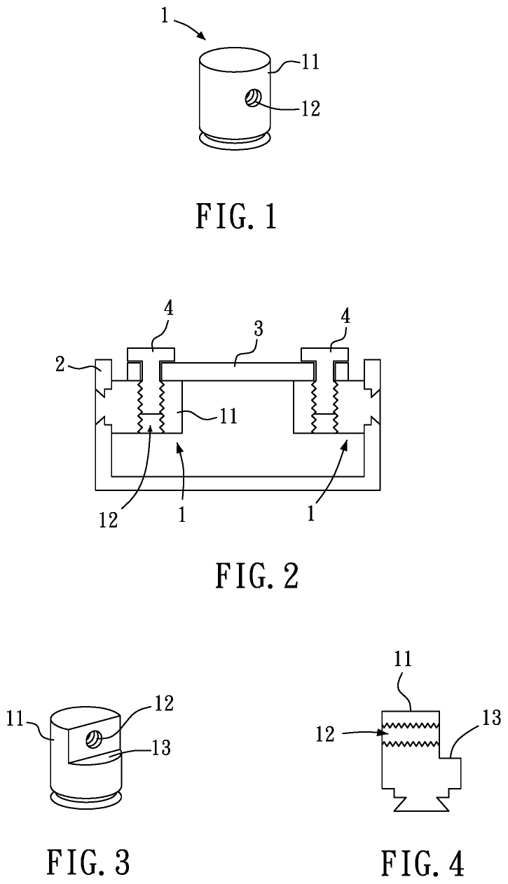

Referring to FIG. 1 and FIG. 2, as shown in the drawings, the present invention provides a lateral locating device 1, including: a body 11, assembled in a first direction thereof to a first object 2, and a fastening portion 12 being provided in a second direction of the body 11 and for fastening connecting, interfering or bearing in the second direction a second object 3 or another object 4.

For assembly, at least two of the lateral locating device 1 can be provided, in the first direction of the body 11, on the first object 2, the lateral locating devices 1 are configured to face each other, the second object 3 is placed in the second direction of the bodies 12, and at least two of other objects are fastened with the fastening portions 12. Thus, the body 11 can be securely coupled to the first object 2, and the second object 3 or another object 4 can be coupled or removed by using the fastening portion 12, so as to complete coupling or separation of at least two objects, achieving the object of repeated quickly coupling and separation.

In a preferred embodiment of the present invention, the first object 2, the second object 3, or another object 4 can be a board, a plate, a block, a circuit board, a metal plate, a plastic plate cylinder, an outer thread, an inner thread, an outer fastener, an inner fastener or an elastic fastener, such that the present invention can adapt to requirements of different application scenarios.

In a preferred embodiment of the present invention, an angle between the first direction of the body 11 and the second direction of the fastening portion 12 is 90 degrees, approximating to 90 degrees, 60 to 120 degrees, or 30 to 150 degrees, such that the present invention can adapt to requirements of different application scenarios.

In a preferred embodiment of the present invention, the body 11 can be assembled with the first object 2 by means of rivet connection, expansion connection, welding connection, lock connection, fastening connection or elastic fastening connection, or the body 11 and the first object 2 are made into an integral (not shown).

In a preferred embodiment of the present invention, the body 11 and the fastening portion 12 are a formed integral or a formed assembly, such that the present invention can adapt to requirements of different application scenarios.

In a preferred embodiment of the present invention, the body 11 and the fastening portion 12 can be assembled by means of movable assembly, fixed riveting connection assembly, fixed expansion connection assembly, lock connection assembly, fastening connection assembly, welding connection assembly, elastic fastening connection assembly, insertion connection assembly or liquid injection before recurring and coupling, such that the present invention can adapt to requirements of different application scenarios.

In a preferred embodiment of the present invention, an angle combination of 90 degrees or approximating 90 degrees between the first direction of the body 11 and the first object 2 is for enabling another object 3 or the second object 4 to steadily engagingly connect, interfere or bearing the first object 2 in an angle of 90 degrees or approximating 90 degrees, such that the present invention can adapt to requirements of different application scenarios.

Referring to FIG. 3 and FIG. 4, as shown in the drawings, in a preferred embodiment of the present invention, the body 11 has a shoulder 13, which can be used for receiving leaning of the second object or another object (not shown). Further, in this embodiment, the fastening portion 12 can be an inner thread, such that the present invention can adapt to requirements of different application scenarios.

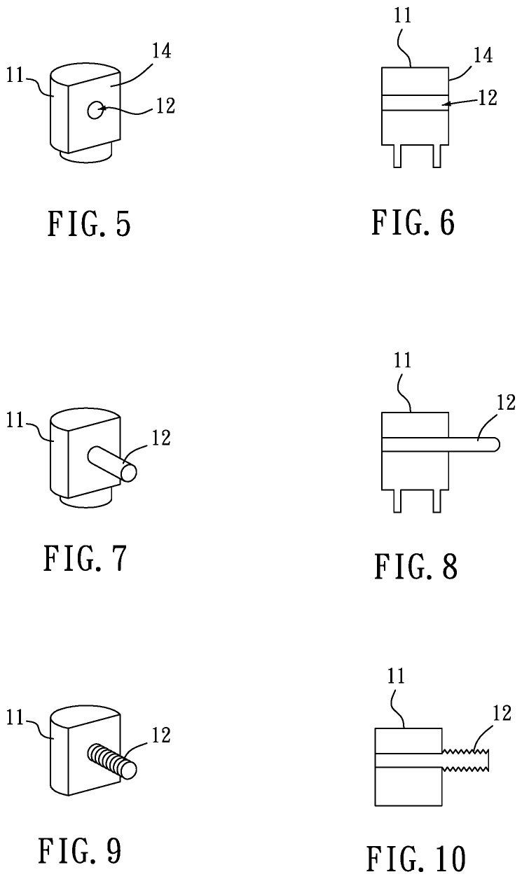

Referring to FIG. 5 and FIG. 6, as shown in the drawings, in a preferred embodiment of the present invention, the body 11 has a leaning surface 14 at a surface near the fastening portion 12. The leaning surface 14 is for receiving leaning of the second object or another object (not shown), and is a planar surface, a stepped surface, a recessed surface, a protruding surface, an inclined surface, an arc surface or a curved surface. Further, in this embodiment, the fastening portion 12 can be a hole, such that the present invention can adapt to requirements of different application scenarios.

Referring to FIG. 7 and FIG. 8, as shown in the drawings, in a preferred embodiment of the present invention, the fastening portion 12 can be a column, such that the present invention can adapt to requirements of different application scenarios.

Referring to FIG. 9 and FIG. 10, as shown in the drawings, in a preferred embodiment of the present invention, the fastening portion 12 can be an outer thread, such that the present invention can adapt to requirements of different application scenarios.

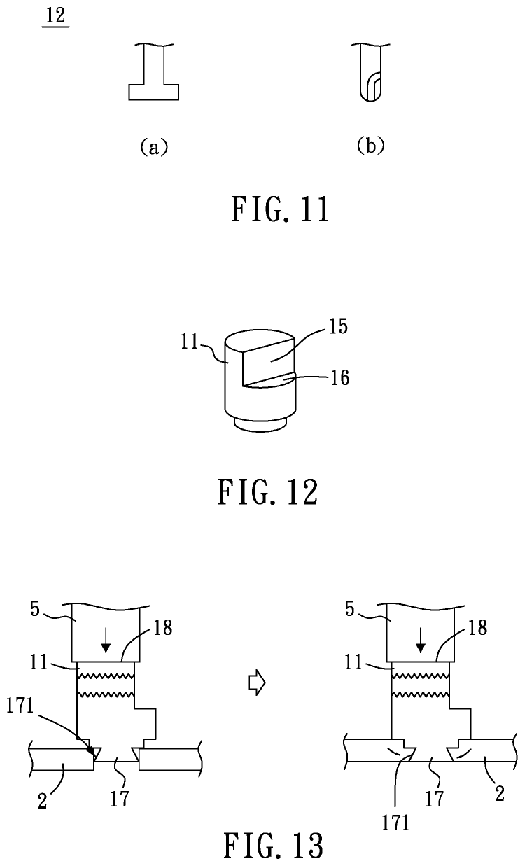

Referring to FIG. 11, as shown in the drawing, in a preferred embodiment of the present invention, the fastening portion 12 can also be an outer fastener (the part a in FIG. 11), an inner fastener (the part a in FIG. 11), a recess, a groove, a protruding fastener, a leaning portion or a step portion, such that the present invention can adapt to requirements of different application scenarios.

Referring to FIG. 12, as shown in the drawing, in a preferred embodiment of the present invention, the body 11 has a leaning portion 15 and a step portion 16 in the second direction. Thus, the leaning portion 15 and the step portion 16 can match each other to receive leaning of the second object or another object (not shown), such that the present invention can adapt to requirements of different application scenarios.

Referring to FIG. 13, as shown in the drawing, in a preferred embodiment of the present invention, the body 12 has an assembly portion 17 having a feed groove 171, and a stamping surface 18 at an end surface thereof for receiving stamping of a stamping part 5, so as to have a material of the first object 2 be pressed or flown into the feed groove 171 and to enable the assembly portion 17 to be assembled with the first object 2.

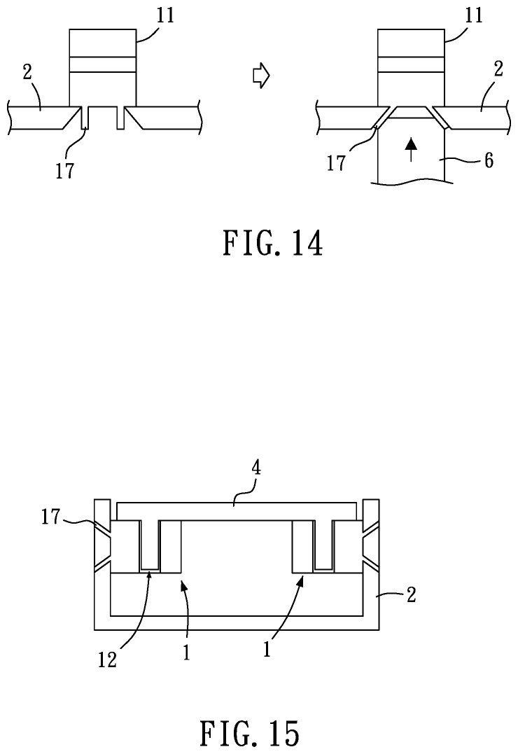

Referring to FIGS. 14 and 15, as shown in the drawings, in a preferred embodiment of the present invention, the assembly portion 17 is pressurized by an external force by using a tool 6 and then assembled by expansion connection to the first object 2. Further, in this embodiment, the fastening portion 12 can be a through hole. To put to use, at least two of the lateral locating device 1 are provided on the first object 2 by using the assembly portion 17 of the body 11, the lateral locating devices 1 are placed facing each other, and another object 4 is coupled by using the fastening portions 12. Thus, the body 11 can be securely coupled to the first object 2, and another object 4 can be coupled or removed by using the fastening portion 12, so as to complete coupling or separation of at least two objects, achieving the object of repeated quickly coupling and separation.

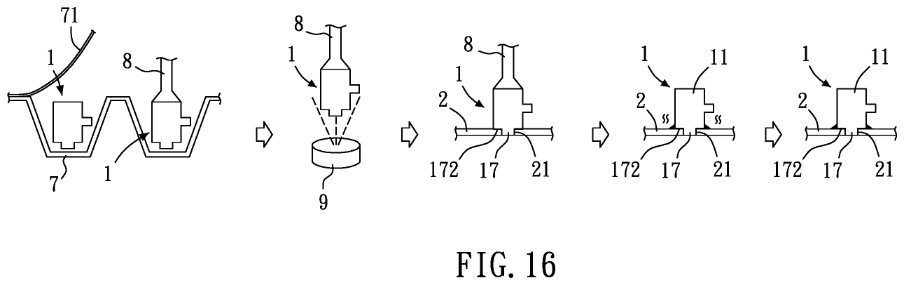

Referring to FIG. 16, as shown in the drawing, in a preferred embodiment of the present invention, a carrier 7 is further included. The carrier 7 is for carrying the lateral locating device 1, and the carrier 7 can be provided with a cover 71 or without the cover 71. Thus, once the body 11 is picked up by a tool 8, a comparison device 9 compares the body 11 and an assembly position of the first object 2, and then precisely places the assembly portion 17 of the body 11 at the assembly position of the first object 2. In this embodiment, the first object 2 has an assembled portion 21 at the assembly position, and the body 11 has a welding surface 172. Once the assembly portion 17 is placed at the assembled portion 21, heat can be applied in the first direction to the welding surface 172 of the body 11, so as to weld the body 11 to the first object 2 and further be cooled and then assembled, such that the present invention can adapt to requirements of different application scenarios.

In a preferred embodiment of the present invention, the assembled portion 21 of the first object 2 can be a through hole, a planar surface, a groove, a recess or a protrusion.

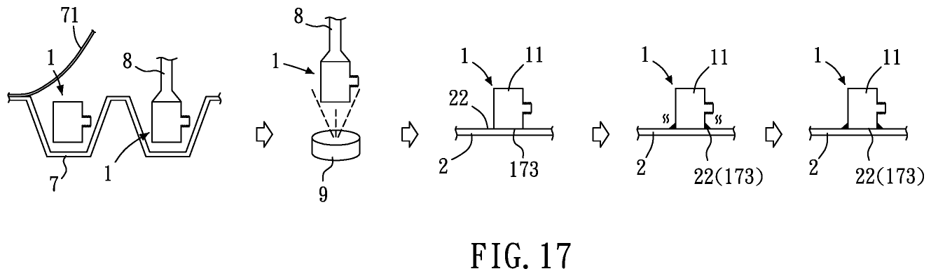

Referring to FIG. 17, as shown in the drawing, in a preferred embodiment of the present invention, the lateral locating device 1 can be carried in the carrier 7. Once the body 11 is picked up by the tool 8, the comparison device 9 compares the body 11 and the assembly position of the first object 2, and precisely places the assembled portion 17 of the body 11 at the assembly position of the first object 2. Further, the first object 2 and the body 11 include solder layers 22 and 173, respectively, at welding position in the first direction. When the body 11 is placed at the first object 2, the solder layers 22 and 173 of the first object 2 and the body 11 can be heated, so as to weld the body 11 to the first object 2 and to be further cooled and assembled, such that the present invention can adapt to requirements of different application scenarios.

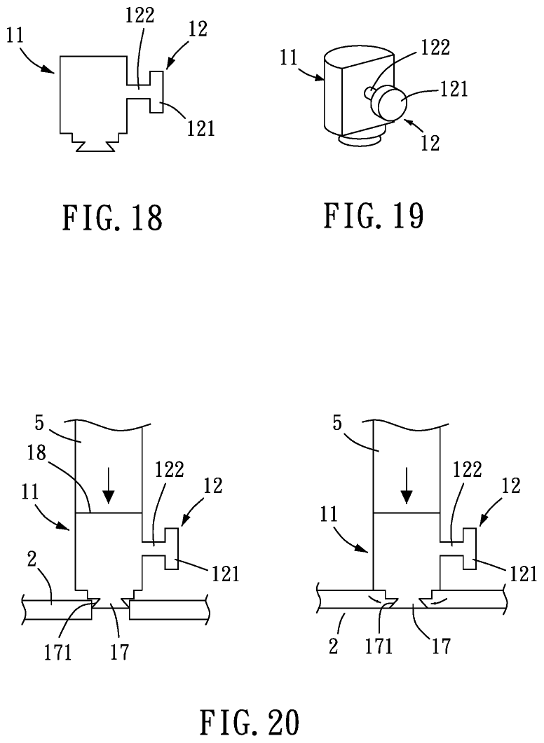

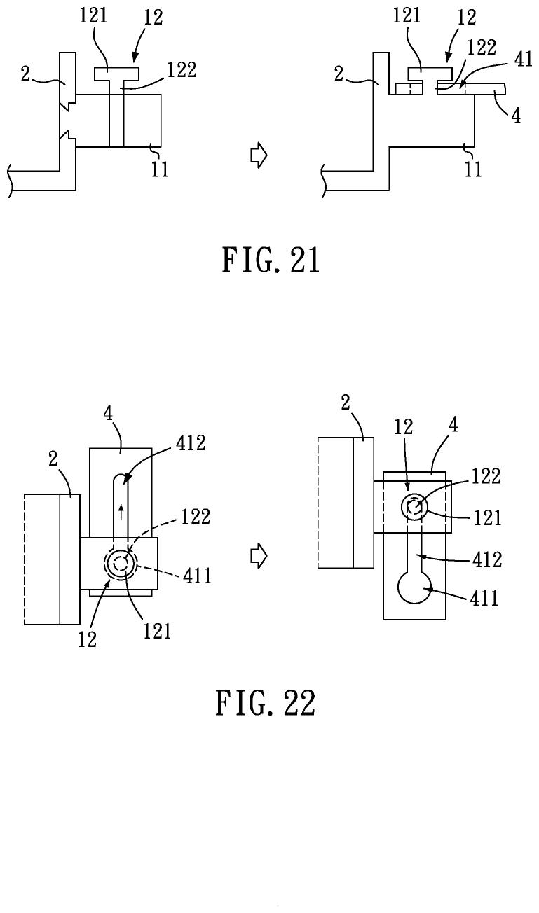

Referring to FIG. 18 to FIG. 22, as shown in the drawings, in a preferred embodiment of the present invention, the fastening portion 12 is a protruding fastener. The protruding fastener has a protruding fastening portion 121 and a neck 122, wherein an outer diameter of the protruding fastening portion 121 is larger than an outer diameter of the neck 122. During assembly, the stamping part 5 stamps the stamping surface 18 of the body 11, so as to have the material of the first object 2 be pressed or flown into the feed groove 171 and to assemble the assembly portion 17 with the first object 2. Then, the fastening portion 12 is fastened with a corresponding fastening portion 41 of another object 4 (or the second object 3). The corresponding fastening portion 41 has an inserting portion 411 and a fitting portion 412. The protruding fastening portion 121 passes through the inserting portion 411, and is fastened in the fitting portion 412 by using the neck 122, so as to fit the fitting portion 412 between the protruding fastening portion 121 and the body 11, such that the present invention can adapt to requirements of different application scenarios.

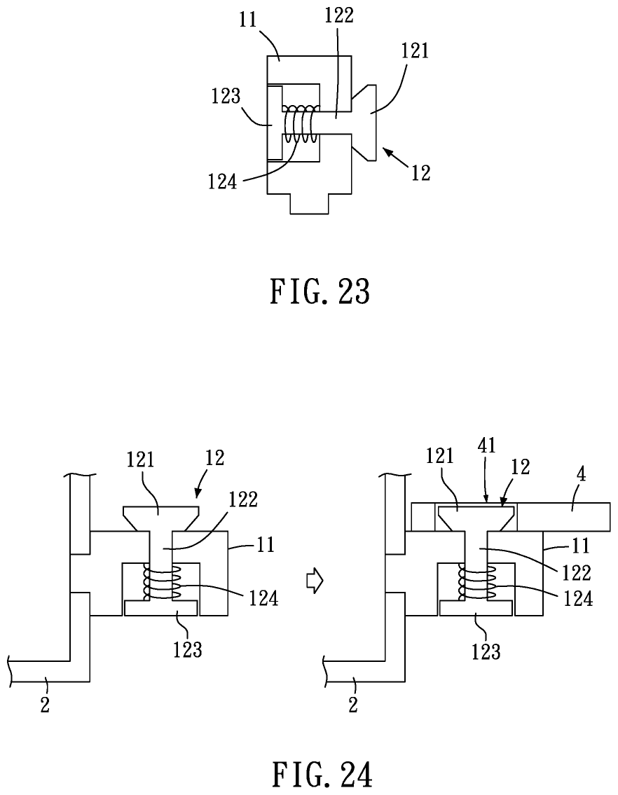

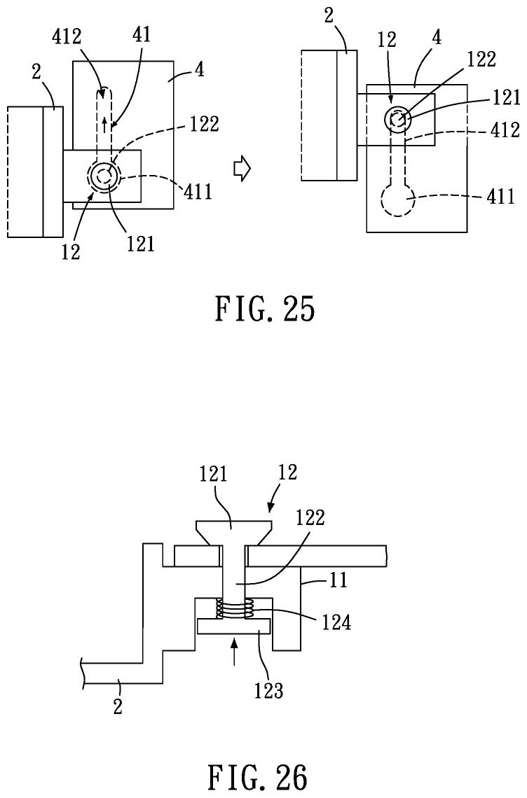

Referring to FIG. 23 to FIG. 26, as shown in the drawings, in a preferred embodiment of the present invention, the fastening portion 12 can be a protruding fastener, which can be fastened in the corresponding fastening portion 41 of another object 4 (or the second object 3). The corresponding fastening portion 41 has an inserting portion 411 and a fitting portion 412. The fastening portion 12 has a protruding fastening portion 121, a neck 122, and a limiting portion 123 extended from the neck 122, and further includes an elastic element 124. One end of the elastic element 124 is abutted against the body 11, and the other end is abutted against the limiting portion 123. Thus, the protruding fastening portion 121 is defined to be constantly in a retracted position. For engaging fastening, the protruding fastening portion 121 is caused to enter the inserting portion 411 and be fastened in the fitting portion 412, and is constantly fitted in the fitting portion 412 by using the elastic force of the elastic element 124, so as to fit the fitting portion 412 between the fastening protruding portion 121 and the body 11, such that the present invention can adapt to requirements of different application scenarios.

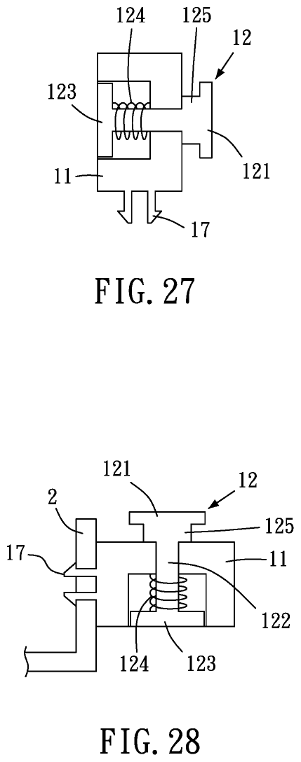

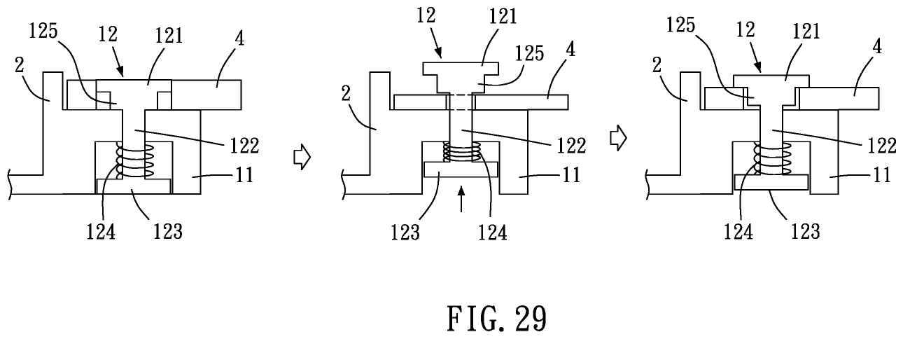

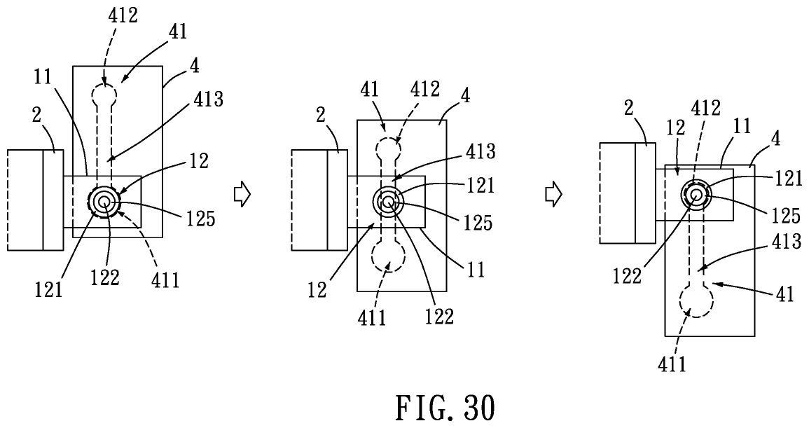

Referring to FIG. 27 to FIG. 30, as shown in the drawings, in a preferred embodiment of the present invention, the fastening portion 12 can be a protruding fastener for fastening into the corresponding fastening portion 41 of another object 4 (or the second object 3). The corresponding fastening portion 41 has an inserting portion 411, an intermediate portion 413 and a fitting portion 412. The fastening portion 12 has a protruding fastening portion 121, an engaging fastening portion 125, a neck 122, and a limiting portion 123 extended from the neck 122, and further includes an elastic element 124. One end of the elastic element 124 is abutted against the body 11, and the other end is abutted against the limiting portion 123. Thus, the protruding fastening portion 121 and the engaging fastening portion 125 are defined to be constantly in a retracted position. For engaging fastening, the fastening protruding portion 121 is caused to enter the inserting portion 411, pass through the intermediate portion 413 by using the neck 122 and be fastened in the fitting portion 412 by using the engaging fastening portion 125, and is constantly fitted in the fitting portion 412 by using the elastic force of the elastic element 124, so as to fit the fitting portion 412 between the fastening protruding portion 121 and the body 11, such that the present invention can adapt to requirements of different application scenarios.

Further, in this embodiment, the assembly portion 17 of the body 11 can be an elastic fastener, so as to assemble the body 11 with the first object 2 by means of elastic fastening, such that the present invention can adapt to requirements of different application scenarios.

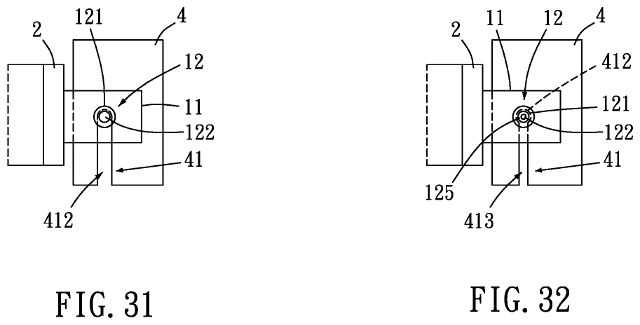

Referring to FIG. 31, as shown in the drawing, in a preferred embodiment of the present invention, the fastening portion 12 can be a protruding fastener for fastening into the corresponding fastening portion 41 of another object 4 (or the second object 3). The corresponding fastening portion 41 has a fitting portion 412. The fastening portion 12 has a protruding fastening portion 121, a neck 122, and a limiting portion extended from the neck 122, and further includes an elastic element. One end of the elastic element is abutted against the body, and the other end is abutted against the limiting portion (not shown). Thus, the protruding fastening portion 121 is defined to be constantly in a retracted position. For engaging connection, the neck 122 is caused to be fastened in the fitting portion 412, and is constantly fitted in the fitting portion 412 by using the elastic force of the elastic element, so as to fit the fitting portion 412 between the protruding fastening portion 121 and the body 11.

Referring to FIG. 32, as shown in the drawing, in a preferred embodiment of the present invention, the fastening portion 12 can be a protruding fastener for fastening into the corresponding fastening portion 41 of another object 4 (or the second object 3). The corresponding fastening portion 41 has an intermediate portion 413 and a fitting portion 412. The fastening portion 12 has a protruding fastening portion 121, an engaging fastening portion 125, a neck 122, and a limiting portion 123 extended from the neck 122, and further includes an elastic element. One end of the elastic element is abutted against the body, and the other end is abutted against the limiting portion (not shown). Thus, the protruding fastening portion 121 and the engaging fastening portion 125 are defined to be constantly in a retracted position. For engaging fastening, the neck 122 passes through the intermediate portion 413, is fastened with the fitting portion 412 by using the engaging fastening portion 125, and is constantly fitted with the fitting portion 412 by using the elastic force of the elastic element, so as to fit the fitting portion 412 between the protruding fastening portion 121 and the body 11, such that the present invention can adapt to requirements of different application scenarios.

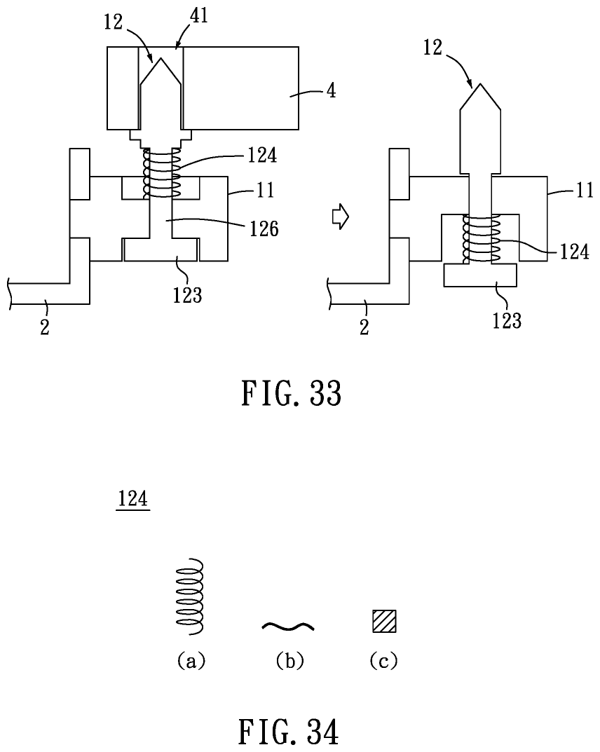

Referring to FIG. 33, as shown in the drawing, in a preferred embodiment of the present invention, the fastening portion 12 has an extension portion 126 having a limiting portion 123, and further includes an elastic element 124. One end of the elastic element 124 is abutted against the fastening portion 12, and the other end is abutted against the body 11. Thus, the fastening portion 12 is constantly in an uplifted position (or a retracted position) by using the elastic force of the elastic element, so as to fasten into the corresponding fastening portion 41 of another object (or the second object 3). The elastic element 124 provides fastening portion 12 with an uplifting elastic force for guiding and fastening into another object 4 (or the second object 3), or for providing another object 4 (or the second object 3) with an elastic force or shock absorption, such that the present invention can adapt to requirements of different application scenarios.

Further, the corresponding fastening portion 41 of another object 4 (or the second object 3) can be a hole, a groove, a pear-shaped hole, a through channel, a through hole, a recess, a protrusion, a stepped body, a planar body, an arc body, a curved body, a channel-like fitting portion, a hole-like fitting portion, a channel-like intermediate portion, or a hole-like inserting portion, such that the present invention can adapt to requirements of different application scenarios.

Referring to FIG. 34, as shown in the drawing, in a preferred embodiment of the present invention, the elastic element 124 can be a spring (the part a in FIG. 33), an elastic piece (the part b in FIG. 33), or an elastic column (the part c in FIG. 33). Further, the elastic force of the elastic element 124 can also thrust (not shown) toward the second direction.

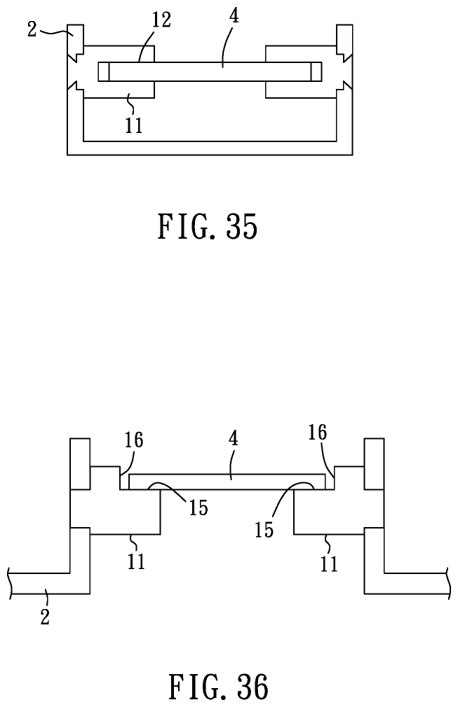

Referring to FIG. 35, as shown in the drawing, in a preferred embodiment of the present invention, the first direction and the second direction are the same direction or approximating directions. When the fastening portion 12 is a slot, the first direction and the second direction are the same direction or approximating directions, such that another object 4 (or the second object 3) can be placed in the fastening portion 12.

Referring to FIG. 36, as shown in the drawing, in a preferred embodiment of the present invention, the body 12 has a leaning portion 15 and a step portion 16 in the second direction. Thus, the leaning portion 15 and the step portion 16 can match each other to receive leaning of another object 4 (or the second object 3), such that the present invention can adapt to requirements of different application scenarios.

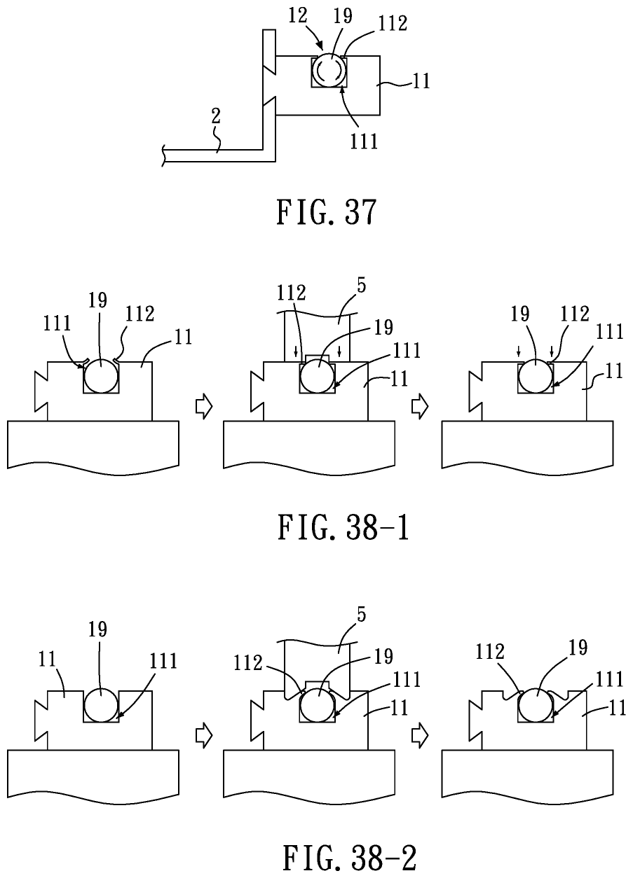

Referring to FIG. 37, as shown in the drawing, in a preferred embodiment of the present invention, the fastening portion 12 (or the leaning portion 15) can be a movable part 19 for movably (e.g., rolling) fastening connecting, interfering or bearing the second object or another object (not shown). Further, the movable part is placed in a placement portion 111 of the body 11, and the body 11 has a stopping portion 112 for stopping the movable part 19 from rolling out of the placement portion 111 of the body 11. The movable part 19 can be a sphere.

Referring to FIGS. 38-1 and 38-2, as shown in the drawings, in a preferred embodiment of the present invention, the stopping portion 112 is larger than an outer diameter of the movable part 19, and is pressurized by an external force from the stamping part 5 for deformation after the movable part 19 is placed in a placement portion 111 of the body 11, so as to limit the movable part 19 within the placement portion 111 by the stopping portion 112, thereby completing the assembly of the movable part 19 (as shown in FIG. 38-1). Further, an external force is applied on the body 11 by the stamping part 5 after the movable part 19 is placed in the placement portion 111 of the body 11 to press and deform the body 11 to further form the stopping portion 112, so as to limit the movable part 19 within the placement portion 111 by the stopping portion 112, thereby completing the assembly of the movable part 19 (as shown in FIG. 38-2).

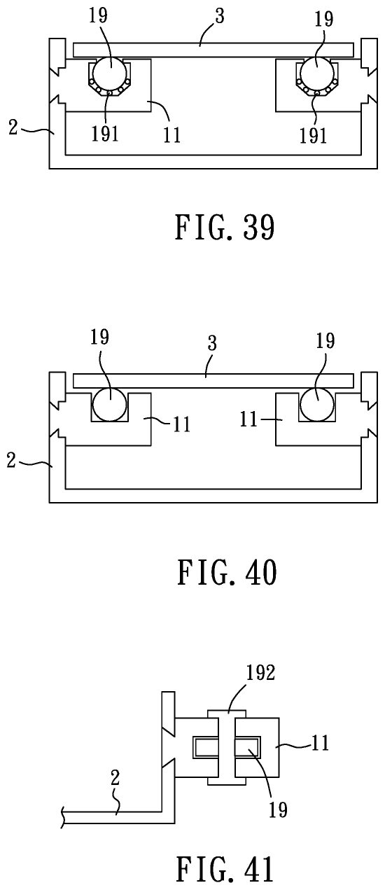

Referring to FIG. 39, as shown in the drawing, in a preferred embodiment of the present invention, another movable part 191 is present between the movable part 19 and the body 11 to increase rolling or moving efficiency of the movable part 19. Further, the second object 3 (or another object 4) is for sliding, moving or rolling on the movable part 19, or the second object 3 (or another body 4) is for driving the movable part 19 to roll, move or slide.

Referring to FIG. 40, as shown in the drawing, in a preferred embodiment of the present invention, the movable part 19 can be a wheel. Thus, the second object 3 (or another object 4) can be similarly used to slide, move or roll on the movable part 19, or the second object 3 (or another object 4) is used for drive the movable part 19 to roll, move or slide.

Referring to FIG. 41, as shown in the drawing, in a preferred embodiment of the present invention, the movable part 19 is bolt connected to the body 11 by an assembly part 192, such that the present invention can adapt to requirements of different application scenarios.

While the present disclosure has been described by means of specific embodiments, numerous modifications and variations could be made thereto by those skilled in the art without departing from the scope and spirit of the present disclosure set forth in the claims.

What is claimed is:

1. A lateral locating device, comprising:
a body, for assembling in a first direction thereof to a first object, comprising in a second direction thereof a fastening portion or a leaning portion for engagingly fastening, interfering or bearing in a second direction a second object or another object.

2. The lateral locating device according to claim 1, wherein the body has a shoulder, which is for receiving leaning of the second object or another object.

3. The lateral locating device according to claim 1, wherein the body has an assembly portion, which is for assembling to the first object.

4. The lateral locating device according to claim 1, wherein the fastening portion is a protruding fastener, the protruding fastener has a protruding fastening portion and a neck, and an outer diameter of the protruding fastening portion is larger than an outer diameter of the neck.

5. The lateral locating device according to claim 4, wherein the protruding fastener is for fastening into a corresponding fastening portion of another object or the second object, the corresponding fastening portion has an intermediate portion and a fitting portion, the fastening portion has a protruding fastening portion, an engaging fastening portion, a neck, and a limiting portion extended from the neck, and further comprises an elastic element, one end of the elastic element is abutted against the body and one other end is abutted against the limiting portion, so as to define the protruding fastening portion and the engaging fastening portion to be constantly in a retracted position, and to, during engaging fastening, have the neck pass through the intermediate portion and be fastened with the fitting portion by using the engaging fastening portion, and to be constantly fitted in the fitting portion by using an elastic force of the elastic element, to fit the fitting portion between the protruding fastening portion and the body.

6. The lateral locating device according to claim 4, wherein the protruding fastener is for fastening into a corresponding fastening portion of another object or the second object, and the corresponding fastening portion has an inserting portion and a fitting portion.

7. The lateral locating device according to claim 6, wherein the protruding fastening portion passes through the inserting portion and is fastened in the fitting portion by using the neck, so as to fit the fitting portion between the protruding fastening portion and the body.

8. The lateral locating device according to claim 7, wherein the protruding fastener is for fastening into a corresponding fastening portion of another object or the second object, the corresponding fastening portion has a fitting portion, the fastening portion has a protruding fastening portion and a neck having a limiting portion and further includes an elastic element, one end of the elastic element is abutted against the body and one other end is abutted against the limiting portion, so as define the protruding fastening portion to be constantly in a retracted position, and to, during engaging fastening, have the protruding fastening portion fasten into the fitting portion and to be constantly fitted in the fitting portion by using an elastic force of the elastic element, to fit the fitting portion between the protruding fastening portion and the body; alternatively, the protruding fastener is for fastening into a corresponding fastening portion of another object or the second object, the corresponding fastening portion has a fitting portion, the fastening portion has a protruding fastening portion, an engaging fastening portion, a neck, and a limiting portion extended from the neck, and further comprises an elastic element, one end of the elastic element is abutted against the body and one other end is abutted against the limiting portion, so as to define the protruding fastening portion and the engaging fastening portion to be constantly in a retracted position and to be constantly fitted in the fitting portion by using the elastic force of an elastic element, to fit the fitting portion between the protruding fastening portion and the body.

9. The lateral locating device according to claim 4, wherein the protruding fastening portion is for fastening into a corresponding fastening portion of another object or the second object, the corresponding fastening portion has a fitting portion, the fastening portion has a protruding fastening portion, a neck, and a limiting portion extended from the neck, and further comprises an elastic element, one end of the elastic element is abutted against the body and one other end is abutted against the limiting portion, so as to define the protruding fastening portion to be constantly in a retracted position, and to, during engaging fastening, fasten the neck in the fitting portion and to be constantly fitted in the fitting portion by using an elastic force of the elastic element, to fit the fitting portion between the protruding fastening portion and the body.

10. The lateral locating device according to claim 1, wherein the fastening portion has an extension portion having a limiting portion and further comprises an elastic element, one end of the elastic element is abutted against the fastening portion and one other end is abutted against the body, so as to have the fastening portion be constantly in an uplifted position or a retracted position by using an elastic force of the elastic element.

11. The lateral locating device according to claim 1, wherein the fastening portion of the leaning portion is a movable part for movably fastening connecting, interfering or receiving leaning of the second object or another object.

12. The lateral locating device according to claim 11, wherein another movable part for increasing rolling or moving efficiency of the movable part is present between the movable part and the body.

13. The lateral locating device according to claim 11, wherein the body has a stopping portion for stopping the movable part from departing from the body.

14. The lateral locating device according to claim 13, wherein the stopping portion is larger than an outer diameter of the movable part, and is for being deformed by pressure of an external force after the movable part is placed in a placement portion of the body, so as to limit the movable part within the placement portion by the stopping portion.

15. The lateral locating device according to claim 13, wherein after the movable part is placed in a placement portion of the body, pressured of an external force is applied on the body to deform a material of the body to form a stopping portion, so as to limit the movable part within the placement portion by the stopping portion.

16. The lateral locating device according to claim 3, wherein the body has in the first direction a stamping surface at an end surface thereof, the stamping surface is for receiving stamping of a stamping part to assemble the assembly portion with the first object, the assembly portion has a feed groove, and the lateral locating device receives pressure of an external force to have a material of the first object be pressed or flown in to the feed groove, so as to assemble the assembly portion with the first object, or assemble the assembly portion of the lateral locating device by expansion connection to the first object by pressure of an external force received.

17. The lateral locating device according to claim 3, wherein after the body is picked up by a tool, a comparison device compares the body and an assembly position of the first object, and places the assembly portion at the assembly position of the first object.

18. The lateral locating device according to claim 1, wherein the body has a welding surface which is for being heated and welded in the first direction at the first object and cooled, and to be assembled with the first object, and the first object is a circuit board.

19. The lateral locating device according to claim 1, further comprising a carrier, wherein the carrier is for carrying the lateral locating device, and the carrier is provided with or without a cover.

20. The lateral locating device according to claim 1, wherein an angle between the first direction and the second direction of the body is 90 degrees, 60 to 120 degrees, or 30 to 150 degrees.
